(19) United States
(12) Patent Application Publication
(10) Pub. No.: US 2013/0159407 A1
(43) Pub. Date: Jun. 20, 2013

(54) METHOD AND APPARATUS FOR TRAFFIC OFFLOADING BETWEEN DEVICES

(71) Applicants: Timo Koskela, Oulu (FI); Gilles Charbit, Farnborough (GB); Tao Chen, Espoo (FI); Samuli Turtinen, Ii (FI); Sami-Jukka Hakola, Kempele (FI)

(72) Inventors: Timo Koskela, Oulu (FI); Gilles Charbit, Farnborough (GB); Tao Chen, Espoo (FI); Samuli Turtinen, Ii (FI); Sami-Jukka Hakola, Kempele (FI)

(73) Assignee: RENESAS MOBILE CORPORATION, Tokyo (JP)

(21) Appl. No.: 13/336,856

(22) Filed: Dec. 23, 2011

(30) Foreign Application Priority Data
Dec. 20, 2011 (GB) 1121902.9

(51) Int. Cl. G06F 15/16

(52) U.S. Cl. 709/204

(57) ABSTRACT

Various methods for enabling D2D connections to exchange P2P data so as to reduce traffic on a network. One example method may comprise constructing a local topology of one or more mobile terminals. The method of this embodiment may also include determining that a mobile terminal of the one or more mobile terminals has initiated a peer to peer session. The method of this embodiment may also include determining, based on the local topology, one or more mobile terminals to act as one or more seeder devices for the peer to peer session. The method of this embodiment may also include causing the local topology to be transmitted to the mobile terminal that has initiated the peer to peer session. In some example embodiments, the mobile terminal is configured to use the local topology to initiate a device to device connection for the peer to peer session.

### CROSS REFERENCE TO RELATED APPLICATIONS

This applications claims the benefit of and priority to United Kingdom patent application number 1121902.9 filed on Dec. 20, 2011, the entirety of which is incorporated by reference as if set forth in its entirety herein.

### TECHNICAL FIELD

Various embodiments relate generally to communications technology, and, more particularly, relate to a method and apparatus for implementing traffic offloading between mobile terminals.

### BACKGROUND

Conventional communication architecture clients (e.g. communications devices, mobile terminals and/or the like) may be configured communicate directly with a server. However, as the number of clients increase, the server load increases by the same magnitude. In a peer to peer (P2P) network each node may act as a client and server and thus may help in reducing the server load. Any node of the P2P network is configured to initiate a connection to another node via a direct connection (wired or wireless) or may connect indirectly through other nodes. Earlier P2P has been mainly discussed in a context of computers that are connected to the internet via broadband and that are utilizing such techniques as those described with respect to file distribution architectures such as Napster, Gnutella, and Bit Torrent etc.

Current mobile terminals can run P2P clients quite effectively may result in the utilization of a disproportionate share of radio resources. Network operators have relied on Deep Packet Inspection (DPI) mechanisms to identify and limit P2P file sharing and voice over internet protocol (VOIP) services usage for specific subscriptions. For example, there are three basic approaches that are used in DPI—(i) application signatures detection method; (ii) transport layer port identification method; and/or (iii) network/transport layer heuristics. These approaches allow the network operator to control usage based on an access type. In some implementations of DPI, the supported access types are Universal Terrestrial Radio Access Network (UTRAN), Global System for Mobile communication (GSM) Enhanced Data rates for GSM Evolution (EDGE) Radio Access Network (GERAN), and 3rd Generation Partnership Project (3GPP) wireless local area network (WLAN).

In the Internet context, P2P traffic (e.g. file sharing, instant messaging, VoIP) is one of the most common drains on total bandwidth. In addition to mobile terminals, PCs and laptops with cellular dongles load the various wireless networks with their P2P traffic. The P2P traffic not only loads the air interface of cellular network, but also the core network which may have to route the traffic back to the same cell. Limiting such popular services to the subscriber's home location may be an effective way for operators to limit impact on the Evolved Universal Terrestrial Radio Access Network (E-UTRAN) and the core network; however, users generally want to use P2P services outside of a home network.

### SUMMARY

Example methods, example apparatuses, and example computer program products are described herein that enable device to device (D2D) connections to exchange P2P data so as to reduce traffic on a network. In some example embodiments a D2D P2P tracker is configured to utilize device information for one or more mobile terminals to determine local topology information. The example D2D P2P tracker is further configured to provide the local topology information to a mobile terminal that is initiating a P2P session. In response, the mobile terminal may then use the local topology to connect or otherwise exchange information with one or more D2D devices in the local topology so as to allow for P2P file sharing session between devices and/or cooperative downloading/uploading of data.

In one embodiment, a method is provided that comprises constructing a local topology of one or more mobile terminals. The method of this embodiment may also include determining that a mobile terminal of the one or more mobile terminals has initiated a peer to peer session. The method of this embodiment may also include determining, based on the local topology, one or more mobile terminals to act as one or more seeder devices for the peer to peer session. The method of this embodiment may also include causing the local topology of the one or more mobile terminals to be transmitted to the mobile terminal that has initiated the peer to peer session. In some example embodiments, the mobile terminal is configured to use the local topology to initiate a device to device connection for the peer to peer session.

In another embodiment, an apparatus is provided that includes at least one processor and at least one memory including computer program code with the at least one memory and the computer program code being configured, with the at least one processor, to cause the apparatus to at least construct a local topology of one or more mobile terminals. The at least one memory and computer program code may also be configured to, with the at least one processor, cause the apparatus to determine that a mobile terminal of the one or more mobile terminals has initiated a peer to peer session. The at least one memory and computer program code may also be configured to, with the at least one processor, cause the apparatus to determine, based on the local topology, one or more mobile terminals to act as one or more seeder devices for the peer to peer session. The at least one memory and computer program code may also be configured to, with the at least one processor, cause the apparatus to cause the local topology of the one or more mobile terminals to be transmitted to the mobile terminal that has initiated the peer to peer session. In some example embodiments, the mobile terminal is configured to use the local topology to initiate a device to device connection for the peer to peer session.

In the further embodiment, a computer program product may be provided that includes at least one non-transitory computer-readable storage medium having computer-readable program instruction stored therein with the computer-readable program instructions including program instructions configured to construct a local topology of one or more mobile terminals. The computer-readable program instructions may also include program instructions configured to determine that a mobile terminal of the one or more mobile terminals has initiated a peer to peer session. The computer-readable program instructions may also include program instructions configured to determine, based on the local topology, one or more mobile terminals to act as one or more seeder devices for the peer to peer session. The computer-readable program instructions may also include program instructions configured to cause the local topology of the one or more mobile terminals to be transmitted to the mobile terminal that has initiated the peer to peer session. In some example embodiments, the mobile terminal is configured to use the local topology to initiate a device to device connection for the peer to peer session.

In yet another embodiment, an apparatus is provided that includes means for constructing a local topology of one or more mobile terminals. The apparatus of this embodiment may also include means for determining that a mobile terminal of the one or more mobile terminals has initiated a peer to peer session. The apparatus of this embodiment may also include means for determining, based on the local topology, one or more mobile terminals to act as one or more seeder devices for the peer to peer session. The apparatus of this embodiment may also include means for causing the local topology of the one or more mobile terminals to be transmitted to the mobile terminal that has initiated the peer to peer session. In some example embodiments, the mobile terminal is configured to use the local topology to initiate a device to device connection for the peer to peer session.

In one embodiment, a method is provided that comprises causing device to device capabilities to be transmitted to a device to device peer to peer tracker. The method of this embodiment may also include receiving a local topology for one or more mobile terminals in radio communications range from the device to device peer to peer tracker. In some example embodiments, the one or more mobile terminals are configured for device to device communications. The method of this embodiment may also include determining, based on the local topology, one or more mobile terminals in radio communications range to act as one or more seeder devices for a peer to peer session. The method of this embodiment may also include causing a device to device connection for a peer to peer session with the one or more seeder devices.

In another embodiment, an apparatus is provided that includes at least one processor and at least one memory including computer program code with the at least one memory and the computer program code being configured, with the at least one processor, to cause the apparatus to at least cause device to device capabilities to be transmitted to a device to device peer to peer tracker. The at least one memory and computer program code may also be configured to, with the at least one processor, cause the apparatus to receive a local topology for one or more mobile terminals in radio communications range from the device to device peer to peer tracker. In some example embodiments, the one or more mobile terminals are configured for device to device communications. The at least one memory and computer program code may also be configured to, with the at least one processor, cause the apparatus to determine, based on the local topology, one or more mobile terminals in radio communications range to act as one or more seeder devices for a peer to peer session. The at least one memory and computer program code may also be configured to, with the at least one processor, cause the apparatus to cause a device to device connection for a peer to peer session with the one or more seeder devices.

In the further embodiment, a computer program product may be provided that includes at least one non-transitory computer-readable storage medium having computer-readable program instruction stored therein with the computer-readable program instructions including program instructions configured to cause device to device capabilities to be transmitted to a device to device peer to peer tracker. The computer-readable program instructions may also include program instructions configured to receive a local topology for one or more mobile terminals in radio communications range from the device to device peer to peer tracker. In some example embodiments, the one or more mobile terminals are configured for device to device communications. The computer-readable program instructions may also include program instructions configured to determine, based on the local topology, one or more mobile terminals in radio communications range to act as one or more seeder devices for a peer to peer session. The computer-readable program instructions may also include program instructions configured to cause a device to device connection for a peer to peer session with the one or more seeder devices.

In yet another embodiment, an apparatus is provided that includes means for causing device to device capabilities to be transmitted to a device to device peer to peer tracker. The apparatus of this embodiment may also include means for receiving a local topology for one or more mobile terminals in radio communications range from the device to device peer to peer tracker. In some example embodiments, the one or more mobile terminals are configured for device to device communications. The apparatus of this embodiment may also include means for determining, based on the local topology, one or more mobile terminals in radio communications range to act as one or more seeder devices for a peer to peer session. The apparatus of this embodiment may also include means for causing a device to device connection for a peer to peer session with the one or more seeder devices.

### BRIEF DESCRIPTION OF THE DRAWINGS

Having thus described some example embodiments in general terms, reference will now be made to the accompanying drawings, which are not necessarily drawn to scale, and wherein:

FIG. 1 illustrates an example D2D environment according to some example embodiments;

FIG. 2 is a block diagram of an apparatus that may be embodied by a mobile terminal in accordance with some example embodiments of the present invention;

FIG. 3 illustrates an example D2D P2P tracker in accordance with some example embodiments;

FIG. 4 is an example flow chart illustrating D2D P2P operations performed by a D2D P2P tracker in accordance with some example embodiments of the present invention;

FIG. 5 is an example flow chart illustrating file sharing in accordance with some example embodiments of the present invention; and

FIG. 6 is an example flow chart illustrating D2D P2P operations performed by a mobile terminal in accordance with some example embodiments of the present invention.

### DETAILED DESCRIPTION

Example embodiments will now be described more fully hereinafter with reference to the accompanying drawings, in which some, but not all embodiments are shown. Indeed, the embodiments may take many different forms and should not be construed as limited to the embodiments set forth herein; rather, these embodiments are provided so that this disclosure will satisfy applicable legal requirements. Like reference numerals refer to like elements throughout. The terms “data,” “content,” “information,” and similar terms may be used interchangeably, according to some example embodiments, to refer to data capable of being transmitted, received, operated on, and/or stored. Further, the term “or” as used herein is not used in an exclusive manner (i.e., as an exclusive-or), but is defined as an operator that comprises at least one option in a collection, and possibly one or more other options within the collection.

As used herein, the term “circuitry” refers to all of the following: (a) hardware-only circuit implementations (such as implementations in only analog and/or digital circuitry); (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions); and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, or other network device.

In some example embodiments of the current invention, a D2D P2P tracker is configured to enable a D2D connection between mobile terminals to facilitate a P2P session. The D2D P2P tracker is configured to provide local topology information to a mobile terminal that is initiating a P2P session. The mobile terminal may then use the local topology to connect or otherwise exchange information with one or more D2D mobile terminals in the local topology so as to enable a P2P session.

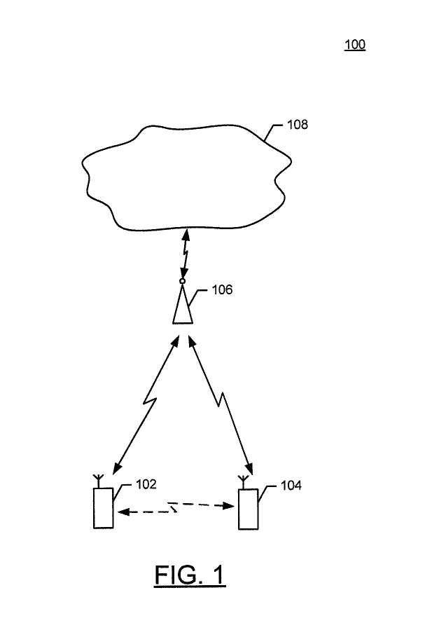

Although the method, apparatus and computer program product may be implemented in a variety of different systems, one example of such a system is shown in FIG. 1, which includes a first communication device (e.g., mobile terminal 102) and a second communication device (e.g. mobile terminal 104) that are capable of communication via an access point 106, such as a base station, a Node B, an evolved Node B (eNB), serving cell or other access point, with a network 108 (e.g., a core network). While the network may be configured in accordance with long term evolution (LTE), LTE advanced (LTE-A), and/or the like, other networks may support the method, apparatus and computer program product of embodiments of the present invention including those configured in accordance with wideband code division multiple access (W-CDMA), CDMA2000, global system for mobile communications (GSM), general packet radio service (GPRS) and/or the like.

The network 108 may include a collection of various different nodes, devices or functions that may be in communication with each other via corresponding wired and/or wireless interfaces. For example, the network may include one or more cells, including access point 106, each of which may serve a respective coverage area. The serving cell and the neighbor cells could be, for example, part of one or more cellular or mobile networks or public land mobile networks (PLMNs). In turn, other devices such as processing devices (e.g., personal computers, server computers or the like) may be coupled to the mobile terminal 102, mobile terminal 104 and/or other communication devices via the network.

A communication device, such as the mobile terminal 102 (also known as user equipment (UE)) or the mobile terminal 104, may be in communication with other communication devices or other devices via the access point 106 and, in turn, the network 108. In some cases, the communication device may include an antenna for transmitting signals to and for receiving signals from a serving cell. Alternatively or additionally the mobile terminal 102 be configured for D2D communications and may be in communications with mobile terminal 104.

When referred to herein, a serving cell includes, but is not limited to a primary serving cell (PCell) and other serving cells such as secondary serving cells (SCell) that may be operating on an access point, such as access point 106. A candidate cell, target cell, neighbor cell and/or the like may also be used herein, and that includes a cell that is not currently a serving cell, but may become a serving cell in the future. A PCell, which may be embodied by an access point, generally includes, but is not limited to, a cell that is configured to perform initial establishment procedures, security procedures, system information (SI) acquisition and change monitoring procedures on the broadcast channel (BCCH) or data channel (PDCCH), and paging. The SCell, which may be embodied by a remote radio head (RRH) and is configured to provide additional radio resources to the PCell. In an embodiment, a “primary band” is the band that is indicated by the serving cell as the band of a serving carrier frequency. The secondary band is the band that is indicated by the serving cell as an additional band (e.g. in addition to primary band), that allows a mobile terminal radio frequency that is supported by the secondary band to also camp on the cell.

In some example embodiments, the mobile terminal 102 and/or the mobile terminal 104 may be a mobile communication device such as, for example, a mobile telephone, portable digital assistant (PDA), pager, laptop computer, vehicle, machine, special purpose apparatus, or any of numerous other hand held or portable communication devices, computation devices, content generation devices, content consumption devices, or combinations thereof. As such, the mobile terminal 102 and/or the mobile terminal 104 may include one or more, processors, such as one or more special purpose processors that may define processing circuitry either alone or in combination with one or more special purpose memories. The processing circuitry may utilize special purpose instructions stored in the memory to cause the mobile terminal 102 to operate in a particular way or execute special purpose functionality when the instructions are executed by the one or more processors. The mobile terminal 102 and/or the mobile terminal 104 may also include special purpose communication circuitry and corresponding hardware/software to enable communication with other devices and/or the network 108.

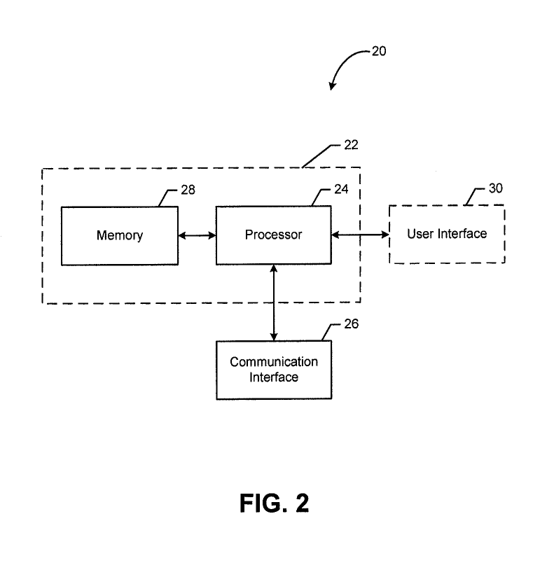

In one embodiment, for example, the mobile terminal 102, mobile terminal 104 and/or the access point 106 may be embodied as or otherwise include an apparatus 20 as generically represented by the block diagram of FIG. 2. While the apparatus 20 may be employed, for example, by a mobile terminal 102, mobile terminal 104 or an access point 106, it should be noted that the components, devices or elements described below may not be mandatory and thus some may be omitted in certain embodiments. Additionally, some embodiments may include further or different components, devices or elements beyond those shown and described herein.

As shown in FIG. 2, the apparatus 20 may include or otherwise be in communication with processing circuitry 22 that is configurable to perform actions in accordance with example embodiments described herein. The processing circuitry may be configured to perform data processing, application execution and/or other special purpose processing and special purpose management services according to an example embodiment of the present invention. In some embodiments, the apparatus or the processing circuitry may be embodied as a chip or chip set or system in package. In other words, the apparatus or the processing circuitry may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus or the processing circuitry may therefore, in some cases, be configured to implement an embodiment of the present invention on a single chip or as a single “system on a chip or a “system in package (SIP).” As such, in some cases, a chip or chipset may constitute means for performing one or more operations for providing the functionalities described herein.

In an example embodiment, the processing circuitry 22 may include a processor 24 and memory 28 that may be in communication with or otherwise control a communication interface 26 and, in some cases, a user interface 30. As such, the processing circuitry may be embodied as a circuit chip (e.g., an integrated circuit chip) configured (e.g., with hardware, software or a combination of hardware and software) to perform operations described herein. However, in some embodiments taken in the context of the mobile terminal 102, the processing circuitry may be embodied as a portion of a mobile computing device or other mobile terminal, vehicle, fixed position apparatus, e.g. water meter, electric power meter.

The user interface 30 (if implemented) may be in communication with the processing circuitry 22 to receive an indication of a user input at the user interface and/or to provide an audible, visual, mechanical or other output to the user. As such, the user interface may include, for example, a keyboard, a mouse, a joystick, a display, a touch screen, gesture, camera, a microphone, a speaker, and/or other input/output mechanisms. The apparatus 20 need not always include a user interface. For example, in instances in which the apparatus is embodied as an access point 106, the apparatus may not include a user interface or alternatively the user interface may be used for special purpose only, e.g. in an emergency case. As such, the user interface is shown in dashed lines in FIG. 2.

The communication interface 26 may include one or more interface mechanisms for enabling communication with other devices and/or networks. In some cases, the communication interface may be any means such as a device or circuitry embodied in either hardware, or a combination of hardware and software that is configured to receive and/or transmit data from/to a network 108 and/or any other device or module in communication with the processing circuitry 22, such as between the mobile terminal 102, mobile terminal 104 and the access point 106. In this regard, the communication interface may include, for example, an antenna (or multiple antennas or antenna system) and supporting hardware and/or software for enabling communications with a wireless communication network and/or a communication modem or other hardware/software for supporting communication via cable, digital subscriber line (DSL), universal serial bus (USB), Ethernet or other methods.

In an example embodiment, the memory 28 may include one or more non-transitory memory devices such as, for example, volatile and/or non-volatile memory that may be either fixed or removable. The memory may be configured to store information, data, applications, instructions or the like for enabling the apparatus 20 to carry out various functions in accordance with example embodiments of the present invention. For example, the memory could be configured to buffer input data for processing by the processor 24 or the memory may be configured to transmit or receive input data at a later time to conserve power. Additionally or alternatively, the memory could be configured to store instructions for execution by the processor. As yet another alternative, the memory may include one of a plurality of databases that may store a variety of files, contents or data sets. Among the contents of the memory, applications may be stored for execution by the processor in order to carry out the functionality associated with each respective application. In some cases, the memory may be in communication with the processor via a bus for passing information among components of the apparatus.

The processor 24 may be embodied in a number of different ways. For example, the processor may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor may be configured to execute instructions stored in the memory 28 or otherwise accessible to the processor. As such, whether configured by hardware or by a combination of hardware and software, the processor may represent an entity (e.g., physically embodied in circuitry—in the form of processing circuitry 22) capable of performing operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the operations described herein.

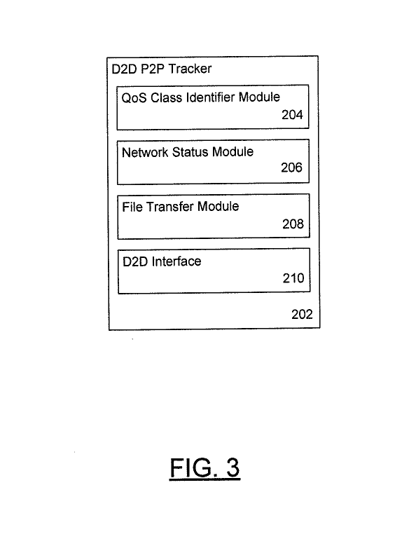

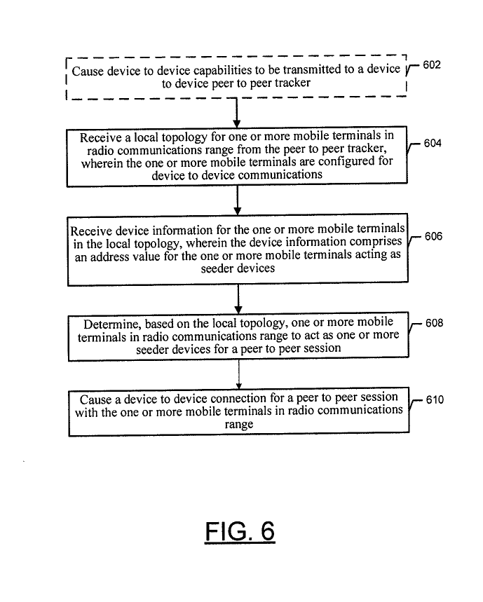

FIG. 3 is an example block diagram of an example system for practicing embodiments of a D2D P2P tracker system. One or more general purpose or special purpose computing systems/devices may be used to implement the D2D P2P tracker 202. In particular the D2D P2P tracker 202 may be implemented on the mobile terminal 102, the mobile terminal 104, the access point 106 and/or another network entity. In some example embodiments, where the D2D P2P tracker 202 is implemented on a mobile terminal, such as mobile terminal 102, the D2D P2P tracker 202 may function as a D2D P2P client. The D2D P2P client may also function to perform the operations outlined in FIG. 6. Alternatively or additionally, as is shown in FIG. 3 the D2D P2P tracker 202 may be implemented as a standalone device when embodied as or otherwise included in apparatus 20 as generically represented by the block diagram of FIG. 2.

In some example embodiments, the D2D P2P tracker 202 may be implemented in or have access to a Packet Data Network Gateway (PDN GW) and can collect the wireless network status information and also communicate with (internet protocol multimedia subsystem-based) P2P application server (e.g. a file sharing sever or the like). Before starting a P2P service, a mobile terminal, such as mobile terminal 102, may register in P2P application server. According to the target IP address and port number, the D2D P2P tracker 202 can note that this as a P2P connection and accordingly send the status information of the serving network, such as network 108, to a P2P application server associated with the mobile terminal registration request.

In one embodiment there the D2D P2P tracker 202 may implement a communications interface, such as communications interface 26 with an application such as an iTracker application (or equivalent). See for example P4P: Explicit Communications for Cooperative Control between P2P and Network Providers buy Haiyong Xie et. al. and TS 23.203, Policy and charging control architecture, v10.4.0, 2011-06 which are incorporated by reference herein. Alternatively or additionally, the D2D P2P tracker 202 may be implemented in an existing iTracker operating in conjunction with a network.

The D2D P2P tracker 202 may comprise one or more distinct computing systems/devices and may span distributed locations. Furthermore, each block shown may represent one or more such blocks as appropriate to a specific embodiment or may be combined with other blocks. For example, in some embodiments the D2D P2P tracker 202 may contain a quality of service (QoS) class identifier module 204, a network status module 206, a file transfer module 208, and/or a D2D interface 210. In other example embodiments, a QoS class identifier module 204, a network status module 206, a file transfer module 208, and/or a D2D interface 210 may be configured to operate on separate systems (e.g. a mobile terminal and an access point, a computer and a remote server, multiple remote servers and/or the like). Also, the D2D P2P tracker 202 may be implemented in software, hardware, firmware, or in some combination to achieve the capabilities described herein.

While the D2D P2P tracker 202 may be employed, for example, by an example mobile terminal, an example access point, a stand-alone system (e.g. remote server), it should be noted that the components, devices or elements described below may not be mandatory and thus some may be omitted in certain embodiments. Additionally, some embodiments may include further or different components, devices or elements beyond those shown and described herein.

In some example embodiments and when the D2D P2P tracker 202 is implemented in apparatus 20, the D2D P2P tracker 202 may reside in a memory 28. In other embodiments, some portion of the contents, some or all of the components of the D2D P2P tracker 202 may be stored on and/or transmitted over other computer-readable media. The components of the D2D P2P tracker 202 preferably execute on one or more processors 24 and are configured to enable P2P communications between devices in a communications area.

In some example embodiments the D2D P2P tracker 202 may be configured to utilize specific device information, such as information related to mobile terminal 102 and mobile terminal 104 to determine local topology information. Local topology information may be determined periodically or may be determined in an instance in which a P2P session is initiated by a mobile terminal, such as mobile terminal 102, that is configured for D2D communications. The specific device information may include location, capabilities, radio interfaces and/or the like. The local topology may consist of potential mobile terminals that are D2D capable seeder candidates, such as those devices that are in proximity and/or communications range with the mobile terminal that initiated the P2P session and may be capable of providing data related to the P2P session. In some example embodiments, the mobile terminal that initiates the P2P session may cause device specific information to be transmitted to the D2D P2P tracker 202 using be application level signaling between a P2P client and/or Core Network signaling via control interfaces.

In some example embodiments the D2D P2P tracker 202 may be configured to cause the local topology information to be transferred to the mobile terminal, in order to, for example, improve the number of seeding peers for a mobile terminal. The local topology information may then further trigger radio level discovery procedures by a mobile terminal. Based on the availability of other mobile terminals in the local topology, a mobile terminal may then connect with the other mobile terminals via a direct connection interface to allow for the exchange of information.

In some example embodiments, a mobile terminal, such as mobile terminal 102, may be configured to have times of availability and time of unavailability. The availability and unavailability times may be dictated by a user, by battery levels, network signaling and/or the like.

Further, and in some example embodiments the D2D P2P tracker 202 may be configured to determine presence status settings for a mobile terminal to allow tracking for D2D-based services at an application layer. The D2D P2P tracker 202 may access an application specific indicator, such as a chat program or social media application to determine the status of a mobile terminal. Further, the D2D P2P tracker 202 may cause an application-specific presence indicator (e.g. “available”, “busy”, “do not disturb”, “Be right back” such as what used in an Instant Messaging session) to be updated based on for example a D2D synchronization status.

The D2D P2P tracker 202 may also be configured to track the location of mobile terminal based on signaling with the Evolved-Serving Mobile Location Center (E-SMLC). The E-SMLC may make use of global positioning system (GPS) based location, LTE positioning, wireless networking positioning to determine the location of the mobile terminal based on positioning procedures of LTE. In case the mobile terminal loses synchronization with a paired device, it may send the “lost” D2D synchronization to paired device to the D2D P2P tracker 202. Otherwise, the mobile terminal may only cause a D2D synchronization to be transmitted in an instance in which it is requested by the D2D P2P tracker 102.

In some example embodiments, the mobile terminal, such as mobile terminal 102, may be configured to receive, from the D2D P2P tracker 202, the local topology information in pull mode to improve seeding pairs, but may also receive topology information in push mode. A mobile terminal, such as mobile terminal 102, operating in push mode may allow for the mobile terminal 102 to receive potential addresses (e.g. IP addresses, radio network IDs, universal MAC addresses etc.) for mobile terminals in the local topology. In some embodiments, the mobile terminal 102 may be configured to take further actions such as radio level discovery upon receiving potential mobile terminal addresses.

In one embodiment the D2D P2P tracker 202 may suggest radio level mobile terminal pairing or mobile terminal clusters (e.g. three or more mobile terminals) in an instance in which potential mobile terminals are determined to be initiating a P2P session to receive the same file. In some example embodiments, the network (or the operator of the network) operating an access point, such as access point 106, may suggest a mobile terminal pair or mobile terminal cluster. In one embodiment the network operator may control a P2P distribution service in the cellular network by integrating and/or implementing the D2D P2P tracker 202 in its control plane functions (e.g. Mobility Management Entity (MME), subscription service).

In one embodiment, the mobile terminal pair or mobile terminal cluster may be established via the assistance of the D2D P2P tracker 202 and a P2P application tracker operating on the mobile terminal, and would be considered a super node which may share the same tracker file and upload/download the unique file segment with other D2D-capable mobile terminals. In some example embodiments, the super node would may consist of a mobile terminal pair or mobile terminal cluster where each of the mobile terminals would be configured to download a part of a file in common agreement to avoid overlapping download/uploads via cellular connection. Sometimes this is referred as cooperative download. For example, from the P2P server perspective, the mobile terminal pair and/or the mobile terminal cluster may be considered as one node so that a unique file segment may be uploaded/downloaded from/to this super node. Further, and by way of example, inside the super node, that comprises multiple mobile terminals, the mobile terminals are configured to share downloaded unique segments.

Furthermore, within the mobile terminal pair and/or mobile terminal cluster, each mobile terminal may have its own sub-tracker file respectively to enable file sharing between mobile terminals. In some example embodiments, the purpose of the super node concept is to avoid the duplicate file uploading/downloading in the air interface between the mobile terminal and access point.

In some example embodiments, as described above, the D2D P2P tracker 202 may include a QoS class identifier module 204, a network status module 206, a file transfer module 208, and/or a D2D interface 210. In some example embodiments, the QoS class identifier module 204 may be specified for P2P via D2D connection between mobile terminals. For example, a P2P D2D client operating on a mobile terminal, such as mobile terminal 102, at application layer may be configured to determine whether (i) a D2D connection with paired mobile terminal available; (ii) a P2P communication pair mobile terminal is needed. The mobile terminal may be configured to use the QoS Class Identifier (QCI) during Packet Data Network (PDN) connection for QoS negotiation when initiating a service session via application layer. Based on the new QCI, the Evolved Packet Core (EPC) can determine that the P2P traffic could take place via D2D connection and may configure the D2D Data Radio Bearer accordingly. The E-UTRAN may then configure the D2D connection resources via Radio Resource Control (RRC) signaling on the control plane. Once the D2D resources have been configured, the paired mobile terminals may start the P2P communication via D2D connection. In some example embodiments, a mobile terminal, having a P2P client, may be configured to, with the help of the D2D P2P tracker 202, cause a connection to be formed with other mobile terminals running with P2P clients and sharing the same file.

In some example embodiments, a network status module 206 may be configured to determine serving network information. The serving network information may include routing information such as Radio Access Bearer (RAB)/radio bearer (RB) mapping information and the associated CELL ID, MME ID, serving gateway (S-GW), etc. The serving network information may also include load information: the load of the serving cell (uplink and downlink), transportation network load and the core network load. The serving network information may include mobile terminal cellular connection quality for mobile terminal-access point link and mobile terminal D2D connection quality for D2D link: mobile terminal supported maximum uplink/downlink data rate estimated based on channel state information (e.g., channel quality indication (CQI), uplink power headroom (UPH) in high speed packet access (HSPA) network; CSI, Power Headroom Report (PHR) in LTE network).

In some example embodiments, the serving network information may be collected via the PDN GW by the P2P D2D tracker 102. Then the P2P D2D tracker 102 may determine the peer selection and service setup according to the reported routing/load information of the mobile terminal's serving network before starting any P2P traffic or any P2P connection. Alternatively or additionally, the D2D P2P tracker 202 may provide P2P application server with compact information after post-processing. Alternatively, D2D P2P tracker can be used for D2D cluster discovery based on the collected information.

In some example embodiments, a file transfer module 208 may be configured to coordinate the transfer of files between mobile terminal pairs and mobile terminal clusters. In case a mobile terminal pair and/or mobile terminal cluster connections may have been established with the assistance of the D2D P2P tracker 202, the P2P application tracker may consider the mobile terminal pair and mobile terminal cluster to be one super node for the file transferring, i.e., the unique file segment would be uploaded (or downloaded) from (or to) any one member of the mobile terminal cluster, and then shared within mobile terminal cluster.

In some example embodiments, a D2D interface 210 may be configured to determine one or multiple of the following direct communication technologies (e.g. LTE. 802.11, WLAN, Bluetooth, Zigbee, etc.) for the device to device communication via the communications interface 26. In some example embodiments, the D2D P2P tracker 202 operation is not tied to a specific D2D interface, so the operator may select the preferred technologies which the D2D P2P tracker 202 supports.

In an example embodiment, components/modules of the D2D P2P tracker 202 may be implemented using standard programming techniques. For example, D2D P2P tracker 202 may be implemented as a “native” executable running on the processor 24, along with one or more static or dynamic libraries. In other embodiments, the D2D P2P tracker 202 may be implemented as instructions processed by a virtual machine. In general, a range of programming languages known in the art may be employed for implementing such example embodiments, including representative implementations of various programming language paradigms, including but not limited to, object-oriented (e.g., Java, C++, C#, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VBScript, and the like), and declarative (e.g., SQL, Prolog, and the like).

The embodiments described above may also use either well-known or proprietary synchronous or asynchronous client-server computing techniques. Also, the various components may be implemented using more monolithic programming techniques, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs. Some embodiments may execute concurrently and asynchronously, and communicate using message passing techniques. Equivalent synchronous embodiments are also supported. Also, other functions could be implemented and/or performed by each component/module, and in different orders, and by different components/modules, yet still achieve the described functions.

In addition, programming interfaces to the data stored as part of the D2D P2P tracker 202, can be made available by standard mechanisms such as through C, C++, C#, and Java APIs; libraries for accessing files, databases, or other data repositories; through languages such as XML; or through Web servers, FTP servers, or other types of servers providing access to stored data. A data store may also be included and it may be implemented as one or more database systems, file systems, or any other technique for storing such information, or any combination of the above, including implementations using distributed computing techniques.

Different configurations and locations of programs and data are contemplated for use with techniques described herein. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, and the like). Other variations are possible. Also, other functionality could be provided by each component/module, or existing functionality could be distributed amongst the components/modules in different ways, yet still achieve the functions described herein.

Furthermore, in some embodiments, some or all of the components of the D2D P2P tracker 202 may be implemented or provided in other manners, such as at least partially in firmware and/or hardware, including, but not limited to one or more application-specific integrated circuits (“ASICs”), standard integrated circuits, controllers executing appropriate instructions, and including microcontrollers and/or embedded controllers, field-programmable gate arrays (“FPGAs”), complex programmable logic devices (“CPLDs”), and the like. Some or all of the system components and/or data structures may also be stored as contents (e.g., as executable or other machine-readable software instructions or structured data) on a computer-readable medium (e.g., as a hard disk; a memory; a computer network or cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use or provide the contents to perform at least some of the described techniques. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

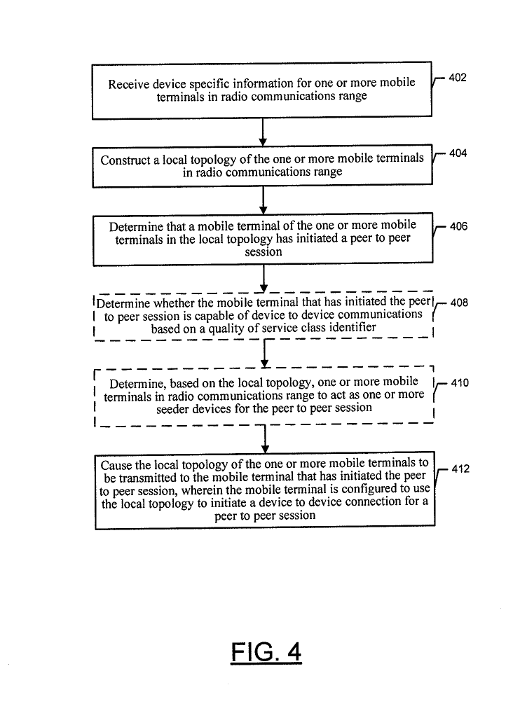

FIGS. 4-6 are flowcharts illustrating the operations performed by a method, apparatus and computer program product, such as apparatus 20 of FIG. 2 in accordance with some example embodiments of the present invention are illustrated. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device 28 of an apparatus employing an embodiment of the present invention and executed by a processor 24 in the apparatus. As will be appreciated, any such computer program instructions may be loaded onto a computer or other special purpose programmable apparatus (e.g., hardware) to produce a special purpose machine, such that the resulting computer or other programmable apparatus provides for implementation of the functions specified in the flowcharts' block(s). These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowcharts' block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowcharts' block(s). As such, the operations of FIGS. 4-6, when executed, convert a computer or processing circuitry into a particular machine configured to perform an example embodiment of the present invention. Accordingly, the operations of FIGS. 4-6 define an algorithm for configuring a computer or processing circuitry 22, e.g., processor, to perform an example embodiment. In some cases, a general purpose computer may be provided with an instance of the processor which performs the algorithm of FIGS. 4-6 to transform the general purpose computer into a particular machine configured to perform an example embodiment.

Accordingly, blocks of the flowcharts support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified as described below. Moreover, in some embodiments additional optional operations may also be included (an example of which is shown in dashed lines in FIG. 4). It should be appreciated that each of the modifications, optional additions or amplifications below may be included with the operations above either alone or in combination with any others among the features described herein.

FIG. 4 is an example flow chart illustrating D2D P2P operations to initiate a D2D connection for a P2P session performed by a D2D P2P tracker in accordance with some example embodiments of the present invention. As shown in operation 402, the apparatus 20 that is embodied, for example, by the D2D P2P tracker 202 may include means, such as the processing circuitry 22, the processor 24, the communications interface 26 or the like, for receiving device specific information for one or more mobile terminals in radio communications range. The device specific information may comprise at least one of location, device to device capabilities or radio interfaces. As shown in operation 404, the apparatus 20 that is embodied, for example, by the D2D P2P tracker 202 may include means, such as the processing circuitry 22, the processor 24, or the like, for constructing a local topology of the one or more mobile terminals in radio communications range.

As shown in operation 406, the apparatus 20 that is embodied, for example, by the D2D P2P tracker 202 may include means, such as the processing circuitry 22, the processor 24, or the like, for determining that a mobile terminal of the one or more mobile terminals in the local topology has initiated a peer to peer session. As shown in operation 408, the apparatus 20 that is embodied, for example, by the D2D P2P tracker 202 may include means, such as the processing circuitry 22, the processor 24, or the like, for determining whether the mobile terminal that has initiated the peer to peer session is capable of device to device communications based on a quality of service class identifier.

As shown in operation 410, the apparatus 20 that is embodied, for example, by the D2D P2P tracker 202 may include means, such as the processing circuitry 22, the processor 24, or the like, for determining, based on the local topology, one or more mobile terminals in radio communications range to act as one or more seeder devices for the peer to peer session. As shown in operation 412, the apparatus 20 that is embodied, for example, by the D2D P2P tracker 202 may include means, such as the processing circuitry 22, the processor 24, the communications interface 26 or the like, for causing the local topology of the one or more mobile terminals to be transmitted to the mobile terminal that has initiated the peer to peer session, wherein the mobile terminal is configured to use the local topology to initiate a device to device connection for a peer to peer session.

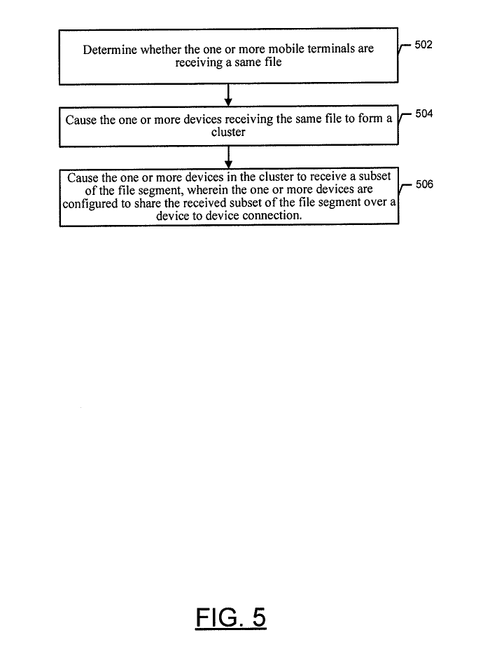

FIG. 5 is an example flow chart illustrating file sharing in accordance with some example embodiments of the present invention. As shown in operation 502, the apparatus 20 that is embodied, for example, by the D2D P2P tracker 202 may include means, such as the processing circuitry 22, the processor 24, or the like, for determining whether the one or more mobile terminals are receiving a same file. As shown in operation 504, the apparatus 20 that is embodied, for example, by the D2D P2P tracker 202 may include means, such as the processing circuitry 22, the processor 24, the communications interface 26 or the like, for causing the one or more devices receiving the same file to form a cluster. As shown in operation 506, the apparatus 20 that is embodied, for example, by the D2D P2P tracker 202 may include means, such as the processing circuitry 22, the processor 24, the communications interface 26 or the like, for causing the one or more devices in the cluster to receive a subset of the file segment, wherein the one or more devices are configured to share the received subset of the file segment over a device to device connection.

FIG. 6 is an example flow chart illustrating D2D P2P operations performed by a mobile terminal, such as mobile terminal 102 and/or mobile terminal 104 in accordance with some example embodiments of the present invention. As shown in operation 602, the apparatus 20 that is embodied, for example, by the mobile terminal 102 and/or the mobile terminal 104 may include means, such as the processing circuitry 22, the processor 24, the communications interface 26 or the like, for causing device to device capabilities to be transmitted to a device to device peer to peer tracker. As shown in operation 604, the apparatus 20 that is embodied, for example, by the mobile terminal 102 and/or the mobile terminal 104 may include means, such as the processing circuitry 22, the processor 24, the communications interface 26 or the like, for receiving a local topology for one or more mobile terminals in radio communications range from the peer to peer tracker, wherein the one or more mobile terminals are configured for device to device communications. As shown in operation 606, the apparatus 20 that is embodied, for example, by the mobile terminal 102 and/or the mobile terminal 104 may include means, such as the processing circuitry 22, the processor 24, the communications interface 26 or the like, for receiving device information for the one or more mobile terminals in the local topology, wherein the device information comprises an address value for the one or more mobile terminals acting as seeder devices.

As shown in operation 608, the apparatus 20 that is embodied, for example, by the mobile terminal 102 and/or the mobile terminal 104 may include means, such as the processing circuitry 22, the processor 24, or the like, for determining, based on the local topology, one or more mobile terminals in radio communications range to act as one or more seeder devices for a peer to peer session. As shown in operation 610, the apparatus 20 that is embodied, for example, by the mobile terminal 102 and/or the mobile terminal 104 may include means, such as the processing circuitry 22, the processor 24, the communications interface 26 or the like, for causing a device to device connection for a peer to peer session with the one or more mobile terminals in radio communications range.

Advantageously, and in accordance with some example embodiments of the current invention, each mobile terminal may be configured for cooperative download, where each mobile terminal may download a part of the file and then the remaining parts of the file may be shared among the mobile terminals in the mobile terminal cluster using D2D communications. Some example embodiments of the current invention may also enhance P2P content distribution. For example, a file might be locally available e.g. inside the current mobile terminal cluster (maybe few hops away) and thus not requiring an open connection to fixed network via multiple hops. Alternatively or additionally, the mobile terminal may download from the network and a local device simultaneously.

Many modifications and other embodiments set forth herein will come to mind to one skilled in the art to which these embodiments pertain having the benefit of the teachings presented in the foregoing descriptions and the associated drawings. Therefore, it is to be understood that the embodiments are not to be limited to the specific ones disclosed and that modifications and other embodiments are intended to be comprised within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions other than those explicitly described above are also contemplated as may be set forth in some of the appended claims. Although specific terms are employed herein, they are used in a generic and descriptive sense only and not for purposes of limitation.

What is claimed is:

1. A method comprising:
constructing, using a processor, a local topology of one or more mobile terminals;
determining that a mobile terminal of the one or more mobile terminals has initiated a peer to peer session;
determining, based on the local topology, one or more mobile terminals to act as one or more seeder devices for the peer to peer session; and
causing the local topology of the one or more mobile terminals to be transmitted to the mobile terminal that has initiated the peer to peer session, wherein the mobile terminal is configured to use the local topology to initiate a device to device connection for the peer to peer session.

2. A method according to claim 1, wherein the one or more mobile terminals acting as one or more seeder devices are in communications range of the mobile terminal that has initiated the peer to peer session.

3. A method according to claim 1 further comprising:
receiving device specific information for one or more mobile terminals in radio communications range, wherein the one or more mobile terminals are configured for device to device communications.

4. A method according to claim 3, wherein the device specific information may comprise at least one of location, device to device capabilities or radio interfaces.

5. A method according to claim 3, wherein the device specific information comprises an address value for the one or more mobile terminals acting as seeder devices to enable radio level discovery.

6. A method according to claim 1 further comprising:
determining whether the mobile terminal that has initiated the peer to peer session is capable of device to device communications based on a quality of service class identifier and an indication of at least one of a cellular interface or wireless local area network interface.

7. A method according to claim 1 further comprising:
determining a mobile terminal status for at least one of the one or more mobile terminals, wherein the at least one of the one or more mobile terminals may provide a presence indicator based on a device to device status.

8. A method according to claim 1 further comprising:
determining whether the one or more mobile terminals are receiving a same file;
causing the one or more mobile terminals receiving the same file to form a cluster; and
causing the one or more mobile terminals in the cluster to receive a file segment, the file segment being a subset of the file, via device to device connection, wherein the one or more mobile terminals are configured to share the file segment over a device to device connection so that each mobile terminal has the entire file.

9. A method according to claim 8 further comprising:
causing a super node to be established based on the cluster, wherein the super node comprises a tracker file and is configured to appear to a peer to peer application as a single entity to upload and download a file; and
causing each mobile terminal in the cluster to have a sub-tracker file to manage file sharing with other members in the cluster.

10. An apparatus comprising:
at least one processor; and
at least one memory including computer program code, the at least one memory and the computer program code configured to, with the at least one processor, cause the apparatus to at least:
construct a local topology of one or more mobile terminals;
determine that a mobile terminal of the one or more mobile terminals has initiated a peer to peer session;
determine, based on the local topology, one or more mobile terminals to act as one or more seeder devices for the peer to peer session; and
cause the local topology of the one or more mobile terminals to be transmitted to the mobile terminal that has initiated the peer to peer session, wherein the mobile terminal is configured to use the local topology to initiate a device to device connection for the peer to peer session.

11. An apparatus according to claim 10 wherein the at least one memory including the computer program code is further configured to, with the at least one processor, cause the apparatus to:
receive device specific information for one or more mobile terminals in radio communications range, wherein the one or more mobile terminals are configured for device to device communications.

12. An apparatus according to claim 11, wherein the device specific information may comprise at least one of location, device to device capabilities or radio interfaces.

13. An apparatus according to claim 11, wherein the device specific information comprises an address value for the one or more mobile terminals acting as seeder devices to enable radio level discovery.

14. An apparatus according to claim 10 wherein the at least one memory including the computer program code is further configured to, with the at least one processor, cause the apparatus to:
determine whether the mobile terminal that has initiated the peer to peer session is capable of device to device communications based on a quality of service class identifier and an indication of at least one of a cellular interface or wireless local area network interface.

15. An apparatus according to claim 10 wherein the at least one memory including the computer program code is further configured to, with the at least one processor, cause the apparatus to:
cause a mobile terminal status to be determined, wherein the mobile terminal may provide a presence indicator based on a device to device status.

16. An apparatus according to claim 10 wherein the at least one memory including the computer program code is further configured to, with the at least one processor, cause the apparatus to:
determine whether the one or more mobile terminals are receiving a same file;
cause the one or more mobile terminals receiving the same file to form a cluster; and
cause the one or more mobile terminals in the to receive a file segment, the file segment being a subset of the file, wherein the one or more mobile terminals are configured to share the subset of the file segment over a device to device connection so that each device has the file.

17. An apparatus according to claim 16 wherein the at least one memory including the computer program code is further configured to, with the at least one processor, cause the apparatus to:
cause a super node to be established based on the cluster, wherein the super node comprises a tracker file and is configured to appear to a peer to peer application as a single entity to upload and download a file segment; and
cause each mobile terminal in the cluster to have a sub-tracker file to manage file sharing with other members in the cluster.

18. A method comprising:
causing device to device capabilities to be transmitted to a device to device peer to peer tracker;
receiving a local topology for one or more mobile terminals in radio communications range from the device to device peer to peer tracker, wherein the one or more mobile terminals are configured for device to device communications;
determining, based on the local topology and using a processor, one or more mobile terminals in radio communications range to act as one or more seeder devices for a peer to peer session; and
causing a device to device connection for a peer to peer session with the one or more seeder devices.

19. A method according to claim 18 further comprising:
receiving device information for the one or more mobile terminals in the local topology, wherein the device information comprises an address value for the one or more mobile terminals acting as seeder devices.

20. A method according to claim 18 further comprising:
requesting a file;
receiving an indication that one or more other mobile terminals are receiving the file;
receiving a subset of the file from a network entity; and
receiving a remainder of the file from the one or more other mobile terminals are receiving the file.
